(19) United States
(12) Patent Application Publication
(10) Pub. No.: US 2003/0226065 A1
(43) Pub. Date: Dec. 4, 2003

(54) Controller area network controller for making a self-diagnosis of a function

(76) Inventor: Yasunori Shingaki, Tokyo (JP)

Correspondence Address: BURNS, DOANE, SWECKER & MATHIS, L.L.P., P.O. Box 1404, Alexandria, VA, 22313-1404, US

(21) Appl. No.: 10/309,120

(22) Filed: Dec. 4, 2002

(30) Foreign Application Priority Data
May 29, 2002 (JP) 2002-156244

(51) Int. Cl. H04B 1/74

(52) U.S. Cl. 714/43

(57) ABSTRACT

In response to a request of a self-diagnosis, transmission data stored in a first slot of a message slot unit is transferred to an intermediate buffer of a control unit, and pieces of serial data obtained from the transmission data are output from a receive-transmit unit of a protocol control unit to a CAN bus. Each piece of serial data is returned to the receive-transmit unit and is stored in the intermediate buffer as loop back data. When the outputting of the serial data is completed, the protocol control unit informs the control unit of transmission completion, the loop back data is transferred to a second slot, and a CPU compares the loop back data of the second slot and the transmission data of the first slot. Therefore, a CAN controller can make the self-diagnosis of a function of the data transmission.

### BACKGROUND OF THE INVENTION

1. Field of the Invention

The present invention relates to a controller area network controller which makes a self-diagnosis of its own function of the data transmission or the data reception.

2. Description of Related Art

In the automotive industry, various electronic control systems have been developed for the purpose of safety, comfortableness, low environmental pollution and low cost. These control systems differ from each other with respect to both data type in communication and reliability. Therefore, these control systems are connected with each other through a plurality of bus lines, and the number of wire harnesses has been increased. To reduce the number of wire harnesses and to transmit a large amount of data at high speed through a plurality of local area networks (LAN), a controller area network (hereinafter, called CAN) is developed.

The CAN denotes a serial communication protocol standardized in the International Organization for Standardization (ISO) and is provided in ISO-11898 and ISO-11519.

FIG. 11 is a view showing the configuration of a conventional CAN controller. In FIG. 11, 1 indicates a central processing unit (hereinafter, called CPU). 2 indicates a conventional CAN controller. 3 indicates a message slot unit having a plurality of slots. Pieces of data are stored in the slots of the message slot unit 3. The message slot unit 3 is composed of memories such as random access memories (RAM). 4 indicates a control unit. The control unit 4 has registers for holding various types of information necessary for data communication and having status flags respectively indicating a communication state. 4a indicates an intermediate buffer located in the control unit 4. 5 indicates a protocol control unit for converting data received from the message slot unit 3 through the control unit 4 into serial data, outputting the serial data to a CANbus (not shown), and converting serial data received through the CAN bus into reception data and transferring the reception data to the message slot unit 3 through the control unit 4 according to a CAN protocol. 6 indicates a transmission terminal CTX of the CAN controller 2. 7 indicates a reception terminal CRX of the CAN controller 2. The conventional CAN controller 2 is connected with other conventional CAN controllers respectively set as a reception unit or a transmission unit through the CAN bus.

Next, an operation of the CAN controller 2 will be described below.

A case where serial data obtained from transmission data according to parallel-to-serial conversion is transmitted from the CAN controller 2 under the control of the CPU 1 is initially described. In this case, the transmission data is stored in an arbitrary slot (in this case, for convenience of explanation, the slot (1)) of the message slot unit 3, and a transmission instruction indicating the transmission of the transmission data is output from the CPU 1 to the control unit 4. Thereafter, the transmission data stored in the slot (1) of the message slot unit 3 is once loaded to the intermediate buffer 4a and is output to the protocol control unit 5.

When the transmission data is received in the protocol control unit 5, the transmission data is converted into serial data, and the serial data is transmitted from the protocol control unit 5 to a CAN bus (not shown) through the transmission terminal CTX 6 according to a CAN protocol. Therefore, the serial data is received in a receiving node of a communication partner (not shown) through the CAN bus.

When the transmission of the serial data is completed without any error in a communication line from the conventional CAN controller 2 to a reception unit of a communication partner, a transmission-normally-completion signal is output from the protocol control unit 5 to the control unit 4, and a status flag relating to the data transmission is set to a status indicating the normal completion of the data transmission in the control unit 4. Therefore, because the status flag relating to the data transmission indicates the normal completion of transmission, when the CPU 1 refers to the status flag of the control unit 4, the CPU 1 can recognize the normal completion of transmission.

Next, a case where serial data is received in the CAN controller 2 under the control of the CPU 1 is described. In this case, pieces of serial data respectively having a prescribed bit length are output from the node of the communication partner to the CAN bus, and the pieces of serial data are received one by one in the protocol control unit 5 of the CAN controller 2 through the reception terminal CRX 7.

Each time the serial data is received in the protocol control unit 5 of the CAN controller 2, reception data obtained from the serial data according to the serial-to-parallel conversion is held in the intermediate buffer 4a of the control unit 4. When a reception-normally-completion signal indicating the completion of reception of the serial data is output from the protocol control unit 5 to the control unit 4, the transmission data held in the intermediate buffer 4a is stored in the slot (2) of the message slot unit 3, and a status flag relating to the data reception is set to a status indicating the normal completion of reception in the control unit 4. Therefore, when the CPU 1 refers to the status flag of the control unit 4, the CPU 1 can recognize the normal completion of reception, and the pieces of serial data stored in the slot (2) of the message slot unit 3 are obtained in the CPU 1.

FIG. 12 shows the structure of a data frame conformable to a CAN protocol.

As shown in FIG. 12, in a CAN protocol, a data frame is used to transmit data from a transmission unit to a reception unit through a CAN bus. The data frame is composed of a start of frame (SOF) indicating the start of the data frame, an arbitration field indicating the priority of this frame, a control field indicating the number of bytes in reserved bits and the number of bytes in data, a data field having contents of data, a cyclic redundancy check (CRC) field for checking transmission error of this frame, a CRC delimiter of the CRC field, an acknowledge (ACK) field indicating the acknowledgment of normal data reception, an ACK delimiter of the ACK field, and an end of frame (EOF) indicating the end of the data frame.

Also, a CAN bus connecting a data transmission unit and a plurality of data reception units is composed of a pair of CAN buses. In the CAN protocol, the CAN bus is set to a dominant level denoting a low level of “0” or a recessive level denoting a high level of “1”. The level of the CAN bus is determined by a difference between electric potential levels of the CAN buses.

Also, in the CAN protocol, when at least one of the units outputs a signal of a low level (or the dominant level) to the CAN bus, the CAN bus is set to the dominant level. Also, only a case where all the units output signals of high level (or the recessive level) respectively, the CAN bus is set to the recessive level.

Also, in the CAN protocol, a data transmission unit sends a signal of a high level to the CAN bus in a time period of the acknowledge field to inform all data reception units of the completion of the data transmission performed in a time period of the data field. In cases where one data reception unit normally receives the data from the data transmission unit, in response to the signal of the high level in the time period of the acknowledge field, the data reception unit sends a signal of a low level to the CAN bus in the time period of the acknowledge field. Therefore, the CAN bus is set to the dominant level, and the data transmission unit can acknowledge that the data transmission is normally completed.

Because the conventional CAN controller 2 has the above-described configuration, in case of the transmission of the data stored in the message slot unit 3, when transmission data is sent from the message slot unit 3 to the protocol control unit 5, there is possibility that the transmission data is undesirably changed to erroneous serial data due to a certain failure occurring in a communication line from the message slot unit 3 to the protocol control unit 5. In this case, even though the transmission data is undesirably changed to the erroneous serial data, the undesirably change of the transmission data to the erroneous serial data cannot be detected in the conventional CAN controller 2, and a problem has arisen that the erroneous serial data is undesirably transmitted to the node of the communication partner.

Also, in case of the reception of the serial data in the conventional CAN controller 2, when serial data received from a communication partner without any error is sent from the protocol control unit 5 to the message slot unit 3 as reception data, there is possibility that the serial data is undesirably changed to erroneous reception data due to a certain failure occurring in a communication line from the protocol control unit 5 to the message slot unit 3, and the erroneous serial data is received in the message slot unit 3. In this case, even though the serial data is undesirably changed to the erroneous reception data, the undesirably change of the serial data cannot be detected in the conventional CAN controller 2, and a problem has arisen that the erroneous reception data is undesirably stored in the message slot unit 3.

### SUMMARY OF THE INVENTION

An object of the present invention is to provide, with due consideration to the drawbacks of the conventional CAN controller 2, a CAN controller in which the transmission or erroneous data or the reception of erroneous data is prevented even though transmission data or received data is undesirable changed to the erroneous data due to a certain failure.

The object is achieved by the provision of a CAN controller including loop back means, comparing means and control means. The loop back means outputs transmission data stored in a slot to a CAN bus as serial data and receives the serial data output to the CAN bus as loop back data in response to a request of a diagnosis. The comparing means compares the transmission data stored in the slot and the loop back data received by the loop back means. The control means makes a diagnosis of a function of the data transmission according to a comparison result.

Therefore, in cases where the transmission data is undesirably changed to erroneous data in a communication line from the slot to the CAN bus due to a certain failure in the self-diagnosis of the function of the data transmission, because the comparing means detects that the transmission data differs from the loop back data, the control means can detect the occurrence of a failure in the CAN controller. Accordingly, the CAN controller can prevent erroneous serial data from being transmitted to a receiving unit.

The object is also achieved by the provision of a CAN controller including transmitting means, receiving means, comparing means and control means. The transmitting means transfers transmission data stored in a slot to an intermediate buffer and outputs the transmission data to a CAN bus. The receiving means transfers reception data received through the CAN bus to the intermediate buffer and stores the reception data in a slot. The comparing means compares the transmission data (or the reception data) of the intermediate buffer and the transmission data (or the reception data) stored in the slot. The control means makes a diagnosis of a function of the data transmission or the data reception according to a comparison result.

Therefore, even though the transmission data (or the reception data) is undesirably changed to erroneous data in a communication line between the slot and the intermediate buffer due to a certain failure, the control means can detect the occurrence of a failure in the communication line. Also, because the occurrence of a failure in a short communication line is detected, the diagnosis of the function of the data transmission or the data reception can be made for a short time.

The object is also achieved by the provision of a CAN controller including quasi-communication means, receiving means, comparing means and control means. The receiving means receives quasi-serial data sent from the quasi-communication means as reception data. The comparing means compares the reception data and the quasi-reception data registered by the quasi-communication means. The control means makes a diagnosis of a function of the data reception according to a comparison result.

Therefore, the occurrence of a failure in the CAN controller in the data reception can be detected by making a self-diagnosis of a function of the data reception.

### BRIEF DESCRIPTION OF THE DRAWINGS

FIG. 1 is a view showing the configuration of a CAN controller according to a first embodiment of the present invention;

FIG. 2 is a view showing the configuration of a protocol control unit of the CAN controller shown in FIG. 1;

FIG. 3 shows an example of an acknowledge signal producing circuit of the protocol control unit shown in FIG. 2;

FIG. 4 is a view showing the configuration of a control unit of the CAN controller shown in FIG. 1;

FIG. 5 is a view showing the configuration of a protocol control unit of a CAN controller according to a second embodiment of the present invention;

FIG. 6 is a view showing the configuration of a protocol control unit of a CAN controller according to a third embodiment of the present invention;

FIG. 7 is a view showing the configuration of a control unit of a CAN controller according to a fourth embodiment of the present invention;

FIG. 8 is a view showing the configuration of a portion of control unit of a CAN controller according to a fifth embodiment of the present invention;

FIG. 9 is a view showing the configuration of a protocol control unit of a CAN controller according to a sixth embodiment of the present invention;

FIG. 10 is an explanatory view showing a loop back function of a control unit of the CAN controller shown in FIG. 1;

FIG. 11 is a view showing the configuration of a conventional CAN controller; and

FIG. 12 shows the structure of a data frame conformable to a CAN protocol.

### DETAILED DESCRIPTION OF THE PREFERRED EMBODIMENTS

Embodiments of the present invention will now be described with reference to the accompanying drawings.

Embodiment 1

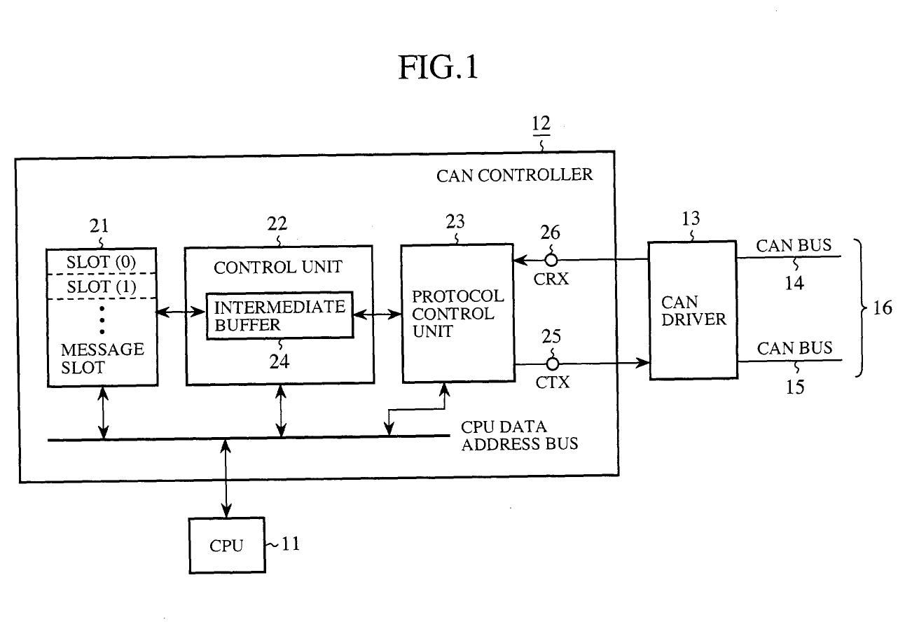

FIG. 1 is a view showing the configuration of a CAN controller according to a first embodiment of the present invention.

In FIG. 1, 11 indicates a CPU (control means and comparing means). 12 indicates a controller area network (CAN) controller. 13 indicates a CAN driver. 16 indicates a CAN bus. 14 and 15 indicate two CAN bus wires of the CAN bus 16 respectively. The CAN controller 12 judges that the CAN bus 16 is set to a dominant level denoting a low level of “0” or a recessive level denoting a high level of “1”. This judgment of the CAN controller 12 is performed according to an electric potential difference between the CAN bus wires 14 and 15.

In the CAN controller 12, 21 indicates a message slot unit having a plurality of slots. Pieces of data (transmission data and reception data) are stored in the slots of the message slot unit 21, and the message slot unit 21 is generally made of memories such as RAM. 22 indicates a control unit. The control unit 22 has registers for setting various types of information necessary for data communication and has status flags respectively indicating a communication state. 24 indicates an intermediate buffer located in the control unit 22. 23 indicates a protocol control unit for receiving and transferring data from/to the message slot unit 21 through the control unit 22 according to a CAN protocol. 25 indicates a transmission terminal (CTX) of the CAN controller 12. 26 indicates a reception terminal CRX of the CAN controller 12.

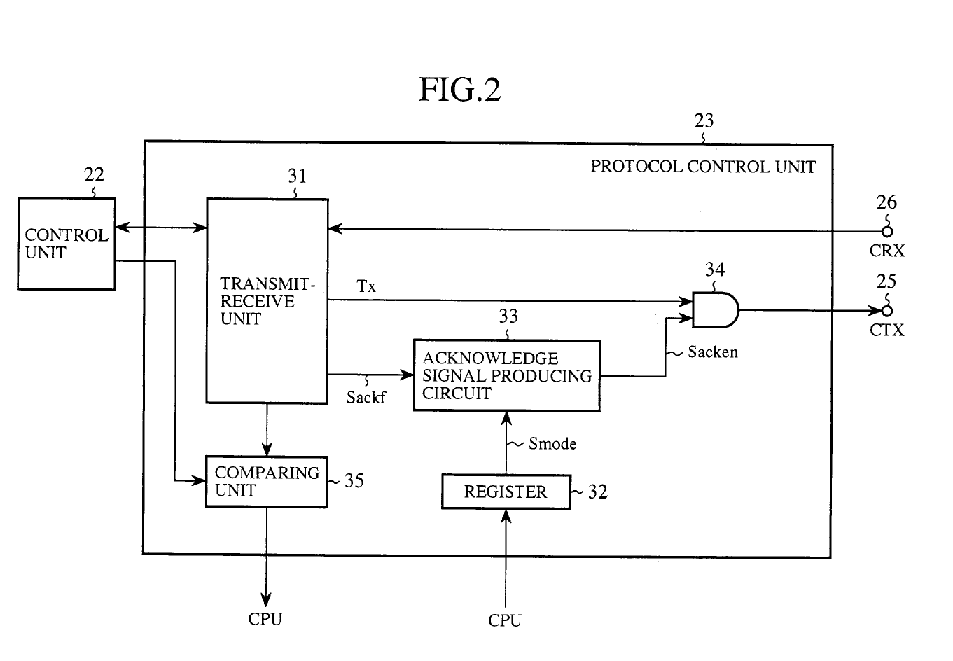

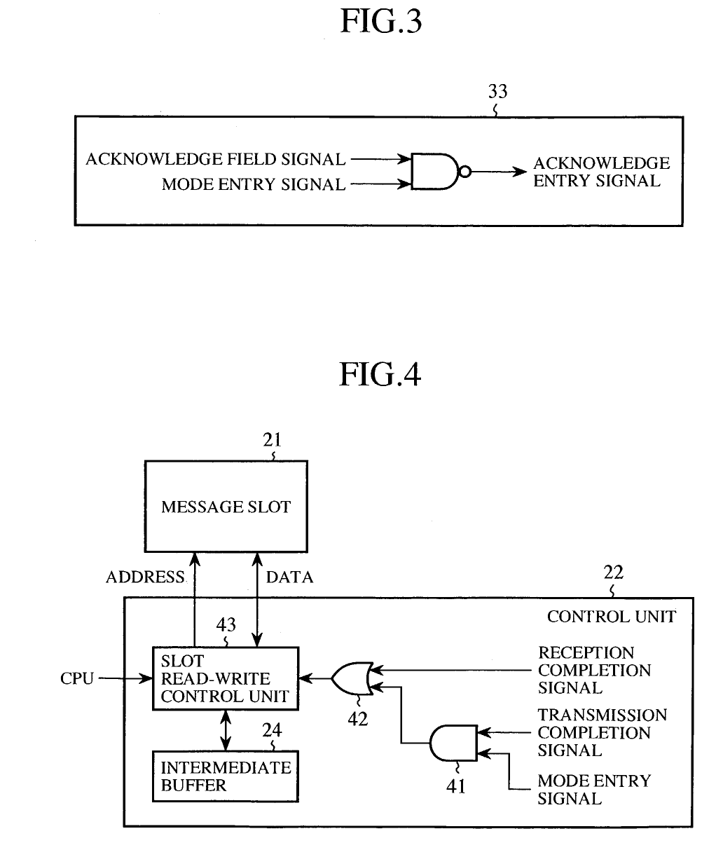

FIG. 2 is a view showing the configuration of the protocol control unit 23, FIG. 3 shows an example of an acknowledge signal producing circuit. In FIG. 2, 31 indicates a transmit-receive unit for receiving transmission data sent from the message slot unit 21 through the control unit 22 in a transmission operation, converting the transmission data into serial data Tx composed of a series of binary values, placing the serial data Tx in a data field of a slot (refer to FIG. 12), outputting the slot including the serial data Tx to an AND circuit 34, receiving a slot including serial data input to the reception terminal (CRX) 26 in a reception operation and converting the serial data into reception data. Here, an acknowledge field signal Sackf is output from the transmit-receive unit 31 to an acknowledge signal producing circuit 33. The acknowledge field signal Sackf is set to a high level when a bit of the slot output from the transmit-receive unit 31 corresponds to the acknowledge field (refer to FIG. 12). 32 indicates a register (or diagnosis receiving means) for outputting a mode entry signal Smode set to a high level in response to a diagnosis mode setting request sent from the CPU 11. The mode entry signal Smode of the high level indicates the entry to the self-diagnosis, and the mode entry signal Smode of a low level indicates no entry to the self-diagnosis.

33 indicates the acknowledge signal producing circuit for receiving the acknowledge field signal Sackf from the transmit-receive unit 31, receiving the mode entry signal Smode from the register 32, outputting an acknowledge entry signal Sacken of a low level to the AND circuit 34 in response to both the acknowledge field signal Sackf of the high level and the mode entry signal Smode of the high level, and outputting an acknowledge entry signal Sacken of a high level to the AND circuit 34 in case of the acknowledge field signal Sackf of the low level or the mode entry signal Smode of the low level. As shown in FIG. 3, the acknowledge signal producing circuit 33 is, for example, formed of an NAND gate.

34 indicates the AND circuit for outputting the serial data Tx received from the transmit-receive unit 31 to the transmission terminal (CTX) 25 during the reception of the acknowledge entry signal Sacken of the high level from the acknowledge signal producing circuit 33, and outputting a signal of a low level to the transmission terminal (CTX) 25 when the acknowledge entry signal Sacken of the low level is received from the acknowledge signal producing circuit 33. That is, a signal of a low level is output from the AND circuit 34 to the transmission terminal (CTX) 25 when a bit of the acknowledge field is output from the transmit-receive unit 31.

A loop back means comprises the transmit-receive unit 31, the acknowledge signal producing circuit 33 and the AND circuit 34.

35 indicates a comparing unit (or comparing means) for comparing transmission data stored in the message slot unit 21 and loop back signal obtained from serial data which is returned to the reception terminal (CRX) 26 and is received in the transmit-receive unit 31.

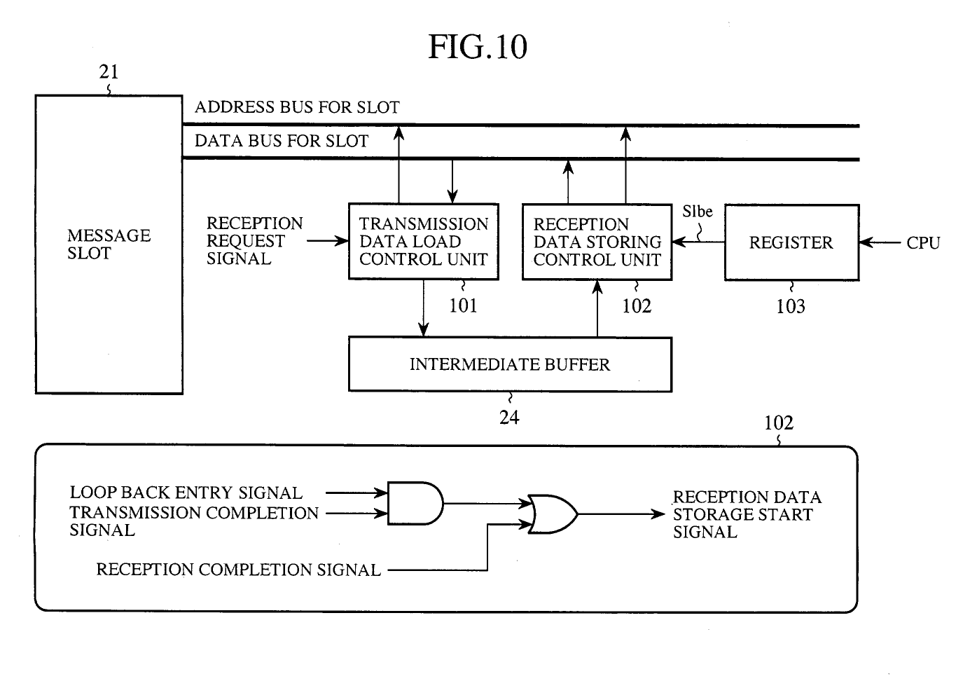

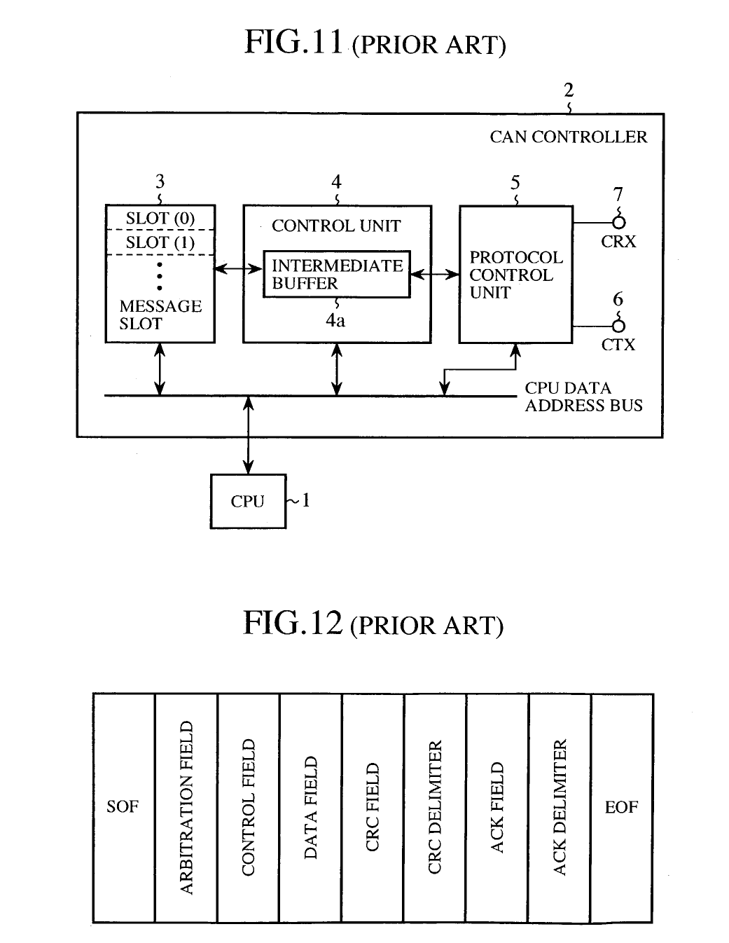

Here, FIG. 10 is an explanatory view showing a loop back function of the control unit 22 performed with the protocol control unit 23. In FIG. 10, when a transmission request signal sent from the CPU 11 is received in a transmission data load control unit 101, transmission data is read out from a slot of the message slot unit 21 set as a transmission slot and is loaded to the intermediate buffer 24 under the control of the transmission data load control unit 101. In cases where a plurality of slots are set as a plurality of transmission slots in the message slot unit 21, because message slot unit identification numbers are assigned to the transmission slots, data of a transmission slot having the lowest message slot unit identification number is loaded to the intermediate buffer 24. Also, as another concept, it is applicable that a comparator of identifier (ID) field data be prepared, a slot having the lowest ID be selected, and data of the selected slot be loaded to the intermediate buffer 24.

Also, when a reception completion signal sent from the protocol control unit 23 is received in a reception data storing control unit 102, reception data sent from the protocol control unit 23 to the intermediate buffer 24 is read out from the intermediate buffer 24 and is stored in the message slot unit 21 under the control of the protocol control unit 23. In this case, ID data is set to each slot of the message slot unit 21, and the reception data read out from the intermediate buffer 24 is stored in a specific slot having the same ID data as that set to the reception data read out from the intermediate buffer 24.

Also, a loop back entry signal Slbe (which is the same as the mode entry signal Smode) set to a high level is stored in a register 103. The loop back entry signal Slbe is writable in the register 103 by the CPU 11. When the loop back entry signal Slbe is sent to the reception data storing control unit 102 under the control of the CPU 11 to control the operation of the reception data storing control unit 102, an entry of a loop back mode is made to the reception data storing control unit 102. In this case, when a transmission completion signal sent from the protocol control unit 23 is received in the reception data storing control unit 102, the reception data storing control unit 102 performs the same operation as that performed in response to the reception completion signal. In brief, when transmission data output from the receive-transmit unit 31 of the protocol control unit 23 is returned to the receive-transmit unit 31 according to a loop back operation of the transmission operation, the transmission data is sent from the protocol control unit 23 to the intermediate buffer 24. Thereafter, the transmission data is transferred from the intermediate buffer 24 to the message slot unit 21 under the control of the reception data storing control unit 102.

An operation of the intermediate buffer 24 in case of data transmission will be described.

When a transmission request signal sent from the CPU 11 is received in the transmission data load control unit 101, transmission data read out from the message slot unit 21 is loaded to the intermediate buffer 24. Thereafter, when a data transmission operation for the CAN bus 16 is actually started, the transmission data is delivered from the intermediate buffer 24 to the protocol control unit 23 every 8 bits. In this case, both parallel-to-serial conversion processing for the transmission data and the outputting of the transmission data to the transmission terminal (CTX) 25 are performed in the protocol control unit 23.

After the delivery of first 8-bit data stored in a buffer area of the intermediate buffer 24 to the protocol control unit 23, the first 8-bit data stored in the buffer area of the intermediate buffer 24 is not required. Therefore, serial data changed from the first 8-bit data and transmitted from the protocol control unit 23 to the CAN bus 16 is returned to the protocol control unit 23 through the CAN bus 16 and the reception terminal (CRX) 26, serial-to-parallel conversion processing is performed for the returned serial data in the protocol control unit 23 to produce loop back 8-bit data, and the loop back 8-bit data is written in the buffer area of the intermediate buffer 24 under the control of the protocol control unit 23.

Therefore, when transmission data read out from the message slot unit 21 to a buffer area of the intermediate buffer 24 is transmitted to the CAN bus 16 through the protocol control unit 23 as serial data in the transmission operation, the serial data is returned to the protocol control unit 23 according to the loop back mode, loop back data obtained from the serial data in the protocol control unit 23 is again stored in the buffer area of the intermediate buffer 24, and the loop-back data of the intermediate buffer 24 is transferred to a slot of the message slot unit 21 in the loop back mode. For example, transmission data transmitted from the slot (0) of the message slot unit 21 is returned to the intermediate buffer 24 as loop-back data, and the loop-back data is stored in the slot (1) of the message slot unit 21 in the loop back mode (in this case, the transmission data transmitted from the slot (0) is still remained in the slot (0) unless the transmission data is erased). In cases where the transmission data stored in the slot (0) of the message slot unit 21 is correctly sent to the CAN bus 16 without an undesirable change of the transmission data due to a certain failure, the loop-back data of the slot (1) is the same as the transmission data stored in the slot (0). In contrast, in cases where the transmission data stored in the slot (0) of the message slot unit 21 is undesirably changed due to a certain failure occurring in a communication line between the message slot unit 21 and the protocol control unit 23, the loop-back data of the slot (1) differs from the transmission data stored in the slot (0).

Accordingly, even though the transmission data transmitted from the message slot unit 21 is undesirably changed to erroneous data due to a certain failure, the occurrence of a failure in a communication line from the slot (0) of the message slot unit 21 to the transmission terminal (CTX) 25 or in a communication line from the reception terminal CRX to the slot (1) of the message slot unit 21 can be detected by comparing the transmission data of the slot (0) and the loop-back data of the slot (1).

In general, in the communication between the CAN controller 12 denoting a data transmission unit and a data reception unit (or a plurality of data reception units) through the CAN bus 16, to judge at a transmission node of the CAN controller 12 that the transmission of data from the CAN controller 12 to the data reception unit is normally completed without failure, a time period of the acknowledge field (refer to FIG. 12) is used. That is, in the time period of the acknowledge field placed after the data field, the CAN controller 12 sends a signal of a high level to the CAN bus 16, and the data reception unit sends a signal of a low level (or a dominant level) to the CAN bus 16 in cases where the transmission data is correctly received in the data reception unit. Therefore, the CAN bus 16 is set to the low level according to the CAN protocol, and the CAN controller 12 acknowledges that the data transmission of the CAN bus 16 is normally completed.

However, in cases where there is no data reception unit, no data reception unit sets the CAN bus 16 to the low level. Therefore, the CAN controller 12 cannot acknowledge that the data transmission of the CAN controller 12 is normally completed. Therefore, regardless of the existence of the data reception unit, a self-acknowledgment function is required of the CAN controller 12 to make the protocol control unit 23 acknowledge the normal completion of the data transmission.

In this embodiment, to execute the self-acknowledgment function, the transmission data is still stored in one slot of the message slot unit 21, loop back data obtained from the transmission data is stored in another slot, and the transmission data and the loop back data are compared with each other by the CPU 11. Therefore, it can be judged whether or not the transmission data can be transmitted without failure in the communication line between the message slot unit 21 and the protocol control unit 23.

FIG. 4 is a view showing the configuration of the control unit 22.

In FIG. 4, 41 indicates an AND circuit for receiving both the mode entry signal Smode sent from the register 32 of the protocol control unit 23 and a transmission completion signal sent from the protocol control unit 23 and outputting the transmission completion signal in cases where the mode entry signal Smode is set to the high level. 42 indicates an OR circuit for receiving both a reception completion signal sent from the protocol control unit 23 and an output signal of the AND circuit 41 and outputting an access instructing signal. 43 indicates a slot read-write control circuit for receiving the access instructing signal output from the OR circuit 42 and having access to both the message slot unit 21 and the intermediate buffer 24. In cases where the access instructing signal is set to the high level, data is transferred from the intermediate buffer 24 to the message slot unit 21 under the control of the slot read-write control circuit 43. In cases where the access instructing signal is set to the low level, data is transferred from the message slot unit 21 to the intermediate buffer 24 under the control of the slot read-write control circuit 43.

Therefore, in cases where the data transmission is normally completed during the self-diagnosis operation indicated by the mode entry signal Smode of the high level, the transmission completion signal is set to the high level so as to set the access instructing signal to the high level, and the loop back data is read out from the intermediate buffer 24 and is stored in the message slot unit 21 by the slot read-write control circuit 43. Also, in cases where the data reception is normally completed regardless of the self-diagnosis operation, the reception completion signal is set to the high level so as to set the access instructing signal to the high level, and reception data is read out from the intermediate buffer 24 and is stored in the message slot unit 21 by the slot read-write control circuit 43. Also, in cases where the self-diagnosis mode is not set in the data transmission, the access instructing signal is set to the low level, and the intermediate buffer 24 is operated to transfer data from the message slot unit 21 to the intermediate buffer 24.

Here, the reception data storing control unit 102 and the register 103 shown in FIG. 10 corresponds to the AND circuit 41, the OR circuit 42 and the slot read-write control circuit 43. Also, the transmission data load control unit 101 shown in FIG. 10 corresponds to the slot read-write control circuit 43.

Next, an operation of the CAN controller 12 will be described below. Data transmission using the CAN controller 12 under the control of the CPU 11 will be initially described on condition that the CAN controller 12 is set in a normal mode (that is, the CAN controller 12 is not set in a self-diagnosis mode) by the CPU 11. In this case, transmission data is stored in an arbitrary slot (for convenience of explanation, transmission data is stored in the slot (0) in this embodiment), and a transmission instruction indicating the transmission of the transmission data from the slot (0) is sent from the CPU 11 to the control unit 22. The transmission instruction of the CPU 11 is received in the slot read-write control circuit 43 of the control unit 22 (refer to FIG. 4). Thereafter, under the control of the slot read-write control circuit 43, the transmission data stored in the slot (0) of the message slot unit 21 is once loaded to the intermediate buffer 24 according to the mode entry signal set to the low level, and the transmission data of the intermediate buffer 24 is output to the protocol control unit 23 every N bits (N is an integral number equal to higher than 1, and N=8 is satisfied in this embodiment).

In the protocol control unit 23, each time 8-bit data of the transmission data sent from the control unit 22 is received in the transmit-receive unit 31, the 8-bit data is converted into serial data Tx, and the serial data Tx placed in the data field of a packet according to the CAN protocol is output to the AND circuit 34. In this case, because the CAN controller 12 is set in the normal mode, the mode entry signal Smode output from the register 32 is set to the low level. Therefore, the acknowledge entry signal Sacken of the high level is input to the AND circuit 34, the serial data Tx received in the AND circuit 34 is output to the transmission terminal (CTX) 25, and the serial data Tx is transmitted to a data reception unit or a plurality of data reception units through the CAN bus 16.

The sending of the 8-bit data from the intermediate buffer 24 to the protocol control unit 23 is repeatedly performed until the transmission of all the transmission data stored in the intermediate buffer 24 is completed.

Also, in the data reception, reception data sent from a data transmission unit through the CAN bus 16 is in put to the reception terminal (CRX) 26 of the CAN controller 12, and the reception data is input to the transmit-receive unit 31.

Next, data transmission using the CAN controller 12 under the control of the CPU 11 will be described on condition that the CAN controller 12 is set in the self-diagnosis mode by the CPU 11 to make a self-diagnosis in the CAN controller 12. That is, in the self-diagnosis, it is checked whether or not transmission data is correctly transmitted without being undesirably changed to erroneous data due to a certain failure occurring in a communication line between the message slot unit 21 and the protocol control unit 23. In this case, the data transmission in the self-diagnosis mode is performed regardless of whether a data reception unit (or a communication partner) exists. Also, a diagnosis mode setting request is sent from the CPU 11 to the register 32 of the protocol control unit 23, and the mode entry signal Smode of the high level is output from the register 32 to the acknowledge signal producing circuit 33.

Also, the entry of the CAN controller 12 to a loop back mode is made by the CPU 11. Therefore, an arbitrary slot (for convenience of explanation, the slot (0) in this embodiment) of the message slot unit 21 is set as a transmission slot, and another arbitrary slot (for convenience of explanation, the slot (1) in this embodiment) of the message slot unit 21 is set as a reception slot.

Thereafter, in the same manner as in the data transmission to a reception node of a communication partner in the normal mode, transmission data is stored in the transmission slot (0), and a transmission instruction indicating the transmission of the transmission data from the slot (0) is sent from the CPU 11 to the control unit 22. The transmission instruction of the CPU 11 is received in the slot read-write control circuit 43 of the control unit 22. Thereafter, under the control of the slot read-write control circuit 43, the transmission data stored in the slot (0) of the message slot unit 21 is once loaded to the intermediate buffer 24, and the transmission data of the intermediate buffer 24 is output to the protocol control unit 23 every 8 bits.

In the protocol control unit 23, each time 8-bit data of the transmission data sent from the control unit 22 is received in the transmit-receive unit 31, the 8-bit data is converted into serial data Tx, and the serial data Tx placed in the data field of a packet according to the CAN protocol is output to the AND circuit 34.

Also, an acknowledge field signal Sackf is output from the transmit-receive unit 31 to the acknowledge signal producing circuit 33. During the data transmission of the serial data Tx, the acknowledge field signal Sackf set to the low level is output from the transmit-receive unit 31. Therefore, the serial data Tx is transmitted from the AND circuit 34 to the CAN bus 16 through the transmission terminal (CTX) 25 and the CAN driver 13. Each piece of serial data of the CAN bus 16 is returned to the transmit-receive unit 31 through the CAN bus 16, the CAN driver 13 and the reception terminal (CRX) 26, the serial data is converted into parallel data in the transmit-receive unit 31, and the parallel data is stored in the intermediate buffer 24 as loop-back data.

Thereafter, the transmission of the transmission data stored in the intermediate buffer 24 to the CAN bus 16 in the time period of the data field is completed, the loop-back data obtained from the transmission data is stored in the intermediate buffer 24 in place of the transmission data. Thereafter, when the transmission of data in a time period of the CRC delimiter (refer to FIG. 12) is completed, a time period of the acknowledge field is started. In the time period of the acknowledge field, data placed in the acknowledge field of the packet is transmitted from the receive-transmit unit 31 to the AND circuit 34, and the acknowledge field signal Sackf set to the high level is output from the receive-transmit unit 31 to the acknowledge signal producing circuit 33. Because the mode entry signal Smode of the high level is received in the acknowledge signal producing circuit 33, the acknowledge entry signal of the low level is output from the acknowledge signal producing circuit 33 to the AND circuit 34 in the time period of the acknowledge field. In this case, a signal of a low level is output from the AND circuit 34 to the CAN bus 16 through the transmission terminal (CTX) 25 and the CAN driver 13. The signal of the low level of the CAN bus 16 is returned to the receive-transmit circuit 31 through the CAN bus 16 and the reception terminal 26 in the time period of the acknowledge field. Therefore, regardless of the existence of a data reception unit or a communication partner, in cases where data of the high level (or the recessive level) is output from the AND circuit 34 to the CAN bus 16 through the transmission terminal (CTX) 25 and is returned to the receive-transmit unit 31 through the reception terminal (CRX) 26 in both a time period of the acknowledge delimiter and a time period of the end of frame (refer to FIG. 12), the protocol control unit 23 judges that the transmission of all the transmission data of the transmission slot (0) is normally completed, and a transmission completion signal is produced in the protocol control unit 23.

In the prior art, data of the low level is output from the reception node of a data reception unit to the transmission node of a data transmission unit in the time period of the acknowledge field. However, in this embodiment, data of the low level is output from the transmission node of the CAN controller 12 and is returned to the reception node of the CAN controller 12 in the time period of the acknowledge field. Therefore, even though there is no data reception unit, the CAN controller 12 functioning as the data transmission unit can acknowledges that the data transmission is normally completed.

Thereafter, the transmission completion signal of the protocol control unit 23 is received in the AND circuit 41 of the control unit 22, the loop-back data stored in the intermediate buffer 24 is sent to the reception slot (1) of the message slot unit 21 under the control of the slot read-write control circuit 43.

Therefore, the transmission data designated by the CPU 11 is stored in the slot (0), and the loop-back data denoting the serial data transmitted to the CAN bus 16 through the transmission terminal (CTX) 25 and returned through the CAN bus 16 and the reception terminal (CRX) 26 is stored in the slot (1). The loop-back data of the slot (1) and the transmission data of the slot (0) are compared with each other in the CPU 11, and the CPU 11 judges that an undesired change occurs in the transmission data in cases where the loop-back data differs from the transmission data. Accordingly, even though the transmission data is undesirably changed to erroneous data due to a certain failure occurring in the communication line from the slot (0) of the message slot unit 21 to the transmission terminal (CTX) 25 or the communication line from the reception terminal (CRX) 26 to the slot (1) of the message slot unit 21 can be detected.

In this embodiment, the comparing unit 35 is not necessarily required because the comparing operation can be performed in the CPU 11. In cases where the comparing unit 35 is disposed in the protocol control unit 23, the transmission data is stored in a transmission buffer area of the intermediate buffer 24, the loop-back data is stored in a reception buffer area of the intermediate buffer 24, and the loop-back data is compared with the transmission data in the comparing unit 35. In cases where the loop-back data differs from the transmission data, the comparing unit 35 notifies the CPU 11 that the transmission data is undesirably changed to erroneous data due to a certain failure.

As is described above, in the first embodiment, when a diagnosis mode setting request output from the CPU 11 is received in the protocol control unit 23, the transmission data stored in the message slot unit 21 is converted into serial data in the protocol control unit 23, and the serial data is transmitted to the CAN bus 16 in the time period of the data field. Also, the serial data is returned from the CAN bus 16, loop back data obtained from the serial data is stored in the message slot unit 21, and the loop back data of the message slot unit 21 is compared with the transmission data of the message slot unit 21 in the CPU 11. In cases where the transmission data is undesirably changed to erroneous data due to a certain failure occurring in the communication line between the message slot unit 21 and the protocol processing unit 23, it is detected in the CPU 11 that the loop-back data differs from the transmission data. Therefore, even though the transmission data is changed to erroneous data, the undesirable change of the transmission data in the communication line can be detected in the CPU 11 in the data transmission operation, and the CAN controller 12 can make a self-diagnosis of the function of the data transmission to diagnose the communication line between the message slot unit 21 and the protocol processing unit 23. Accordingly, the CAN controller 12 can prevent erroneous data from being transmitted to a communication partner due to a failure of the CAN controller 12.

Also, in the first embodiment, the transmission data stored in the message slot unit 21 is once stored in the intermediate buffer 24 of the control unit 22 and is transmitted in response to a transmission instruction of the CPU 11 every 8 bits. Also, the loop-back data is once stored in the intermediate buffer 24 every 8 bits and is stored in the message slot unit 21 in response to a transmission completion signal. The transmission completion signal is produced in the protocol control unit 23 after the protocol control unit 23 acknowledges that the transmission of all the transmission data is normally completed without any failure in a communication line between the CAN controller 12 and a data reception unit or a communication partner, and the transmission completion signal is output from the protocol control unit 23 to the control unit 22. Therefore, the loop-back data can be reliably transferred to the message slot unit 21.

Also, in the first embodiment, the loop back mode is adopted in the CAN controller 12. Therefore, the transmission data is still stored in a slot of the message slot unit 21, and the loop-back data is stored in another slot of the message slot unit 21. Accordingly, the loop back data can be reliably compared with the transmission data.

Embodiment 2

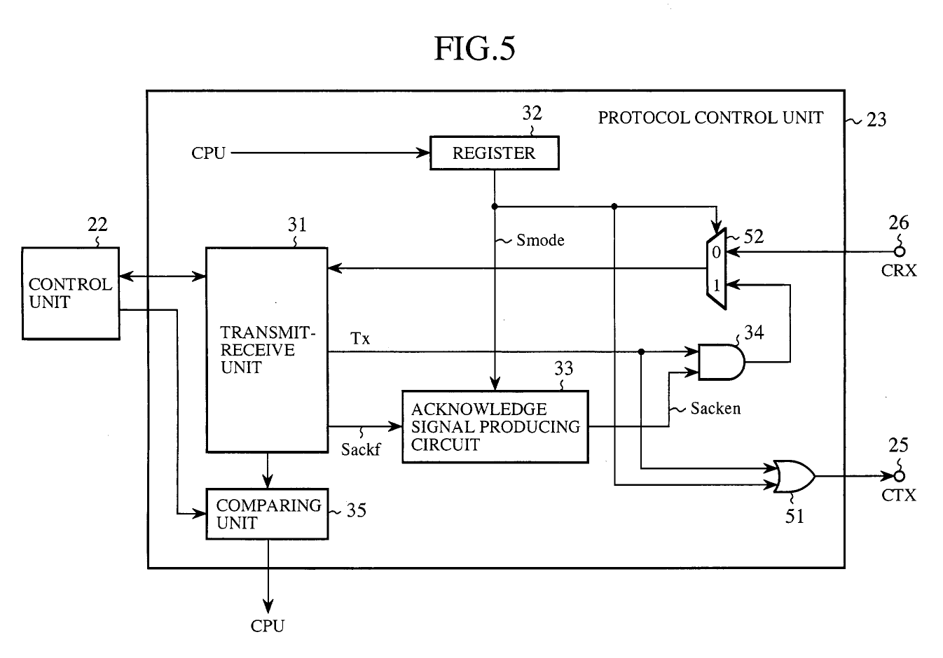

FIG. 5 is a view showing the configuration of a protocol control unit of a CAN controller according to a second embodiment of the present invention. The constituent elements, which are the same as those shown in FIG. 2, are indicated by the same reference numerals as those of the constituent elements shown in FIG. 2, and additional description of those constituent elements is omitted.

In FIG. 5, 51 indicates an OR circuit for outputting a logical sum of both the mode entry signal Smode output from the register 32 and the serial data Tx output from the transmit-receive unit 31. 52 indicates a selector for receiving data received in the reception terminal (CRX) 26 and data output from the AND circuit 34, receiving the mode entry signal Smode output from the register 32, outputting the data received in the reception terminal (CRX) 26 to the transmit-receive unit 31 in case of the reception of the mode entry signal Smode set to the low level, and outputting the data output from the AND circuit 34 to the transmit-receive unit 31 in case of the reception of the mode entry signal Smode set to the high level. A loop back means comprises the OR circuit 51, the selector 52, the transmit-receive unit 31, the acknowledge signal producing circuit 33 and the AND circuit 34.

In the first embodiment, in cases where the CAN controller 12 makes a self-diagnosis of the function of the data transmission, serial data obtained from the transmission data is output to the CAN bus 16 through the CAN driver 13, and the serial data is returned to the transmit-receive unit 31 through the CAN bus 16, the CAN driver 13 and the reception terminal (CRX) 26. However, it is not necessarily required to output data to the CAN bus 16 in the self-diagnosis. In a second embodiment, the serial data Tx output from the AND circuit 34 is returned to the transmit-receive unit 31 without passing the CAN bus 16.

In detail, in case of the self-diagnosis made in the CAN controller 12, because the mode entry signal Smode of the high level is input to the OR circuit 51, the mode entry signal Smode of the high level is always output from the OR circuit 51 to the transmission terminal (CTX) 25. The reason that the mode entry signal Smode of the high level denoting the recessive level in the CAN bus 16 is output to the transmission terminal (CTX) 25 is to prevent the self-diagnosis made in the CAN controller 12 from interrupting the communication between other nodes performed in the same network as that of the CAN controller 12. The operation that a signal of the low level denoting the dominant level is output from the transmission node of the CAN controller 12 in the time period of the acknowledge field violates the CAN protocol, and there is a possibility that a packet erroneously transmitted is judged due to the operation violating the CAN protocol to be correctly transmitted.

Also, the serial data Tx produced in the transmit-receive unit 31 is output from the AND circuit 34 in the time period of the data field, and a signal of the low level is output from the AND circuit 34 in the time period of the acknowledge field. Because the mode entry signal Smode of the high level is input to the selector 52, loop-back data denoting the serial data Tx in the time period of the data field is sent to the transmit-receive unit 31, and data of the low level output from the AND circuit 34 in the time period of the acknowledge field is sent to the transmit-receive unit 31.

Also, the loop back mode is adopted in advance in the CAN controller 12, the transmission data is stored in a slot of the message slot unit 21, the loop-back data is stored in another slot of the message slot unit 21, and the loop back data is compared with the transmission data in the CPU 11. Therefore, even though the transmission data is undesirably changed to erroneous data due to a certain failure occurring in a communication line between the message slot unit 21 and the protocol control unit 23, the undesirable change of the transmission data in the communication line can be detected in the CPU 11 in the data transmission.

In contrast, in cases where the self-diagnosis is not set, the mode entry signal Smode set to the low level is input to the selector 52 and the OR circuit 51. Therefore, in case of the data transmission, the serial data Tx output from the receive-transmit unit 31 is output to the CAN bus 16 through the OR circuit 51 and the transmission terminal (CTX) 25. Also, in case of the data reception, reception data input to the reception terminal (CRX) 26 through the CAN bus 16 is received in the receive-transmit unit 31 through the selector 52.

As is described in the second embodiment, the serial data Tx output from the AND circuit 34 is returned to the transmit-receive unit 31 without being output to the transmission terminal (CTX) 25 or the CAN bus 16 and is stored as loop-back data in the message slot unit 21 through the intermediate buffer 24. Accordingly, the CAN controller 12 can make a self-diagnosis of the function of the data transmission without interrupting the communication between nodes of other CAN controllers performed in the network.

Embodiment 3

In the CAN protocol, when an error occurring in a communication line between a transmission unit and a reception unit is detected in the transmission unit or the reception unit during the communication between the transmission unit and the reception unit, the transmission unit or the reception unit is required to transmit an error frame to the reception unit or the transmission unit. To reliably detect the occurrence of a communication error in the transmission unit or the reception unit during the communication between the transmission unit and the reception unit, it is required of the CAN controller 12 to make a self-diagnosis of the function of the transmission of the error frame. However, in the first embodiment or the second embodiment, because the CAN controller 12 makes a self-diagnosis of the function of the data transmission in both a communication line between the message slot unit 21 and the transmission terminal (CTX) 25 and a communication line between the message slot unit 21 and the reception terminal (CRX) 26, the normal communication is performed between the transmission terminal (CTX) 25 (or the transmission node) and the reception terminal (CRX) 26 (or the reception node) through the CAN bus 16 in cases where there is no communication partner. Therefore, the CAN controller 12 cannot make a self-diagnosis of the function of the transmission of the error frame in the first embodiment or the second embodiment.

In a third embodiment, to make a self-diagnosis of the function of the transmission of the error frame in the CAN controller 12, an arbitrary bit of serial data Tx output from the receive-transmit unit 31 is specified, loop-back serial data is produced by intentionally changing a binary value (or a signal level) of the serial data Tx at the specified bit to another binary value, and the occurrence of an error is detected by comparing loop back data received in the receive-transmit unit 31 and transmission data output from the receive-transmit unit 31 as the serial data Tx.

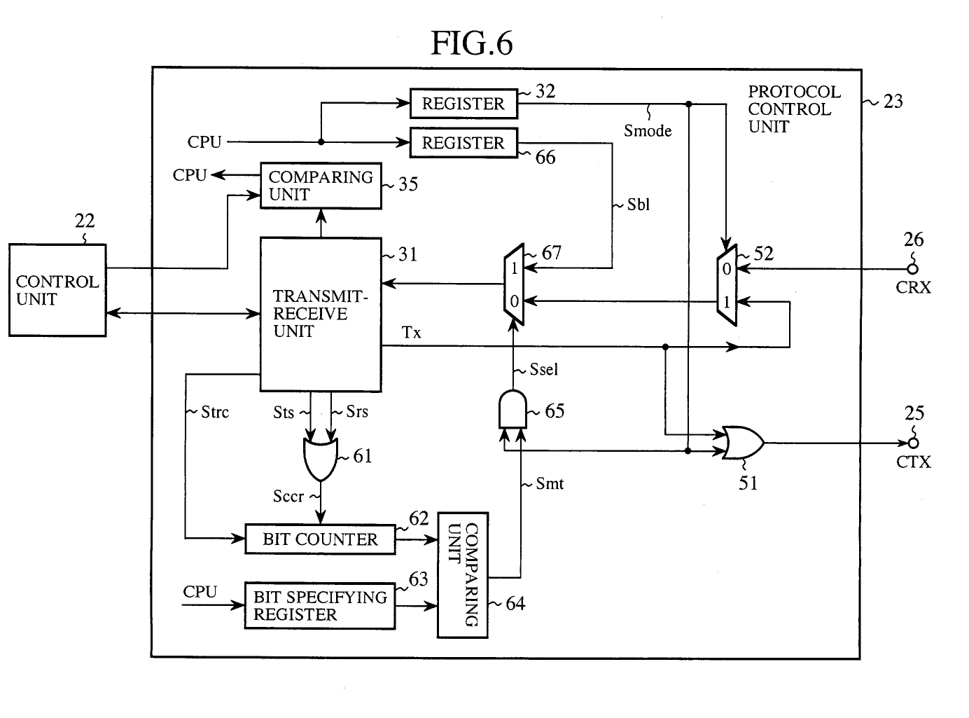

FIG. 6 is a view showing the configuration of a protocol control unit of a CAN controller according to a third embodiment of the present invention. The constituent elements, which are the same as those shown in FIG. 5, are indicated by the same reference numerals as those of the constituent elements shown in FIG. 5, and additional description of those constituent elements is omitted.

In FIG. 6, 61 indicates an OR circuit for calculating a logical sum of both a transmit status signal Sts and a receive status signal Srs and outputting a count clock reset signal Sccr set to a level of the logical sum. The transmit status signal Sts is set to the high level when a data transmission operation is started in the CAN controller 12. The receive status signal Srs is set to the high level when a data reception operation is started in the CAN controller 12. Therefore, only when a data transmission operation or a data reception operation is started in the CAN controller 12, the count clock reset signal Sccr set to the high level is output from the OR circuit 61. 62 indicates a bit counter for resetting a count value to zero when the count clock reset signal Sccr set to the high level is received from the OR circuit 61 and incrementing the count value each time a transmit-receive clock signal Strc set to the high level is received from the transmit-receive unit 31. The transmit-receive clock signal Strc is set to the high level in the transmit-receive unit 31 each time one bit of serial data is output from the transmit-receive unit 31. Therefore, in cases where serial data Tx is output from the transmit-receive unit 31, the count value of the bit counter 62 reset to zero at the start of the data transmission is incremented each time one bit of the serial data Tx is output. 63 indicates a bit specifying register for setting a specific bit specified by the CPU 11 as a register value. A binary value of the specific bit of the serial data Tx output from the transmit-receive unit 31 is planned to be changed to another binary value.

64 indicates a comparing unit for comparing the count value of the bit counter 62 and the register value of the bit specifying register 63 and outputting a matching signal Smt set to the high level when the count value is equal to the register value. Therefore, when a binary value of the serial data placed at the specific bit is output from the transmit-receive unit 31, the matching signal Smt set to the high level is output from the comparing unit 64. 65 indicates an AND circuit for outputting a selection signal Ssel of the high value when both the matching signal Smt of the high level output from the comparing unit 64 and the mode entry signal Smode of the high level output from the register 32 are received.

66 indicates a register for holding a binary value different from that of the specific bit of the serial data Tx output from the transmit-receive unit 31 under the control of the CPU 11 and outputting a bit level signal Sbl set to a high or low level corresponding to the held binary value. 52 indicates the selector for receiving the serial data Tx output from the transmit-receive unit 31 and reception data input to the reception terminal (CRX) 26 through the CAN bus 16 (refer to FIG. 1), receiving the mode entry signal Smode from the register 32, outputting the serial data Tx in case of the reception of the mode entry signal Smode of the high level, and outputting the reception data in case of the reception of the mode entry signal Smode of the low level. 67 indicates a selector for receiving the serial data Tx or the reception data output from the selector 52 and the bit level signal Sbl output from the register 66, receiving the selection signal Ssel from the AND circuit 65, outputting the serial data or the reception signal to the transmit-receive unit 31 in case of the reception of the selection signal Ssel of the low level, and outputting the level value of the bit level signal Sbl to the transmit-receive unit 31 in case of the reception of the selection signal Ssel of the high level. Therefore, in cases where the self-diagnosis mode is selected in the CAN controller 12, when binary values of the serial data Tx placed at bits different from the specific bit are output from the transmit-receive unit 31, the selection signal Ssel is set to the low level, and the binary values of the serial data Tx are returned to the transmit-receive unit 31 through the selectors 52 and 67. In contrast, when a binary value of the serial data Tx placed at the specific bit is output from the transmit-receive unit 31, the selection signal Ssel is set to the high level, and a binary value different from the binary value of the serial data Tx placed at the specific bit is output from the register 66 to the selector 67 and is sent to the transmit-receive unit 31. Therefore, loop back serial data, in which the binary value at the specific bit differs from that of the serial data Tx at the specific bit, is received in the transmit-receive unit 31, and loop back data is obtained by converting the loop back serial data according to the serial-to-parallel conversion.

A data changing means comprises the OR circuit 61, the bit counter 62, the bit specifying register 63, the comparing unit 64, the AND circuit 65, the register 66 and the selector 67.

Next, an example of an operation of the CAN controller 12 will be described below.

As an example, the self-diagnosis mode is selected in the CAN controller 12 to set the mode entry signal Smode to the high level, serial data Tx obtained from transmission data of the message slot unit 21 is expressed by 8 bits of “00011010”, and loop back serial data received in the transmit-receive unit 31 is planned to be set to data “00111010” obtained by forcedly setting a binary value “0” of the serial data Tx placed at the third bit from the top to another binary value “1”. In this case, the specific bit equal to 3 is set in the bit specifying register 63, and the bit level signal Sbl of the high level corresponding to the binary value of “1” is set in the register 66.

A count value of the bit counter 62 is set to zero before the outputting of the serial data Tx from the transmit-receive unit 31, and the count value is incremented each time one bit of the serial data Tx is output from the transmit-receive unit 31. When the binary value “0” of the serial data Tx placed at the third bit from the top is output from the transmit-receive unit 31, the count value of the bit counter 62 is set to 3 equal to the value set in the bit specifying register 63. Therefore, the matching signal Smt set to the high level is output from the comparing unit 64 to the AND circuit 65, and the selection signal set to the high level is output from the AND circuit 65 to the selector 67. Therefore, the binary value “1” output from the register 66 is sent to the transmit-receive unit 31 through the selector 67 as the third bit of loop back serial data.

In contrast, when the binary values of the serial data Tx placed at bits different from the third bit from the top are output from the transmit-receive unit 31, the selection signal set to the low level is output from the AND circuit 65 to the selector 67. Therefore, the binary values of the serial data Tx output from the transmit-receive unit 31 are returned to the transmit-receive unit 31 through the selectors 52 and 67 as bits of the loop back serial data other than the third bit from the top.

Thereafter, the loop back serial data is converted into loop back data and is compared with the transmission data in the CPU 11. Because the binary value of the loop back serial data at the third bit from the top differs from that of the serial data Tx, the occurrence of an error is detected in the CPU 11, and an error frame is output from the CAN controller 12 to the CAN bus 16 through the OR circuit 51 when the mode entry signal Smod is et to the low level.

As is described above, in the third embodiment, an arbitrary bit of the serial data Tx output from the transmit-receive unit 31 is specified, a binary value of the serial data Tx at the specified bit is specified, and the binary value of the serial data Tx at the specified bit is changed to produce loop back serial data received in the transmit-receive unit 31. Therefore, when loop back data obtained from the loop back serial data is compared with transmission data corresponding to the serial data Tx, the occurrence of an error in the serial data Tx is detected.

Accordingly, the CAN controller 12 can reliably make a self-diagnosis of the function of the transmission of the error frame.

Embodiment 4

In the first embodiment, the failure occurring in the communication line between the message slot unit 21 and the protocol control unit 23 is detected to make the self-diagnosis of the function of the data transmission. However, in a fourth embodiment, the failure occurring in a communication line between the message slot unit 21 and the intermediate buffer 24 is detected to make a self-diagnosis of the function of the data transmission, and it is not required of the protocol control unit 23 to output serial data Tx in the self-diagnosis mode.

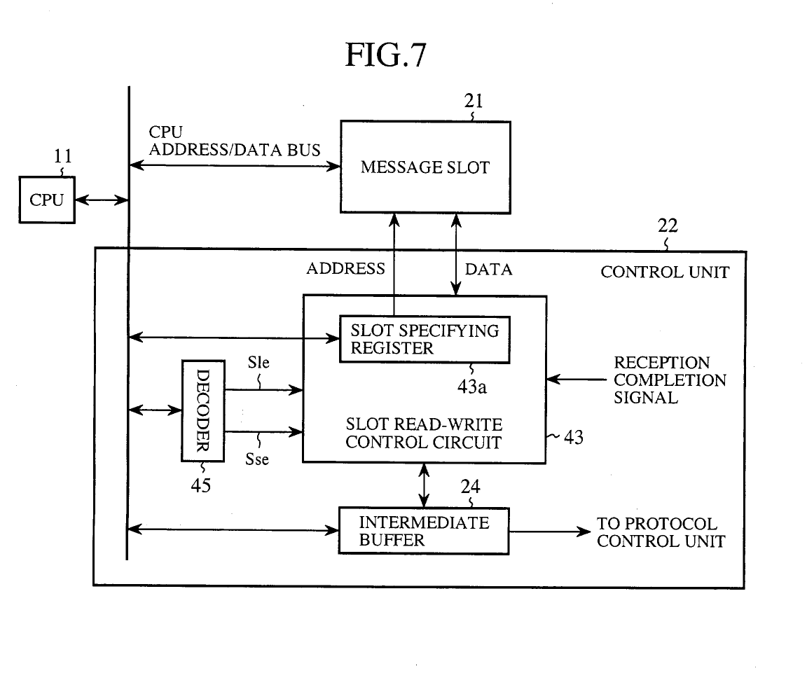

FIG. 7 is a view showing the configuration of a control unit of a CAN controller according to a fourth embodiment of the present invention. The constituent elements, which are the same as those shown in FIG. 4, are indicated by the same reference numerals as those of the constituent elements shown in FIG. 4, and additional description of those constituent elements is omitted.

In FIG. 7, 43a indicates a slot specifying register for holding a slot number indicating one slot of the message slot unit 21 under the control of the CPU 11. 45 indicates a decoder for decoding an instruction of the CPU 11 to a load entry signal Sle or a storage entry signal Sse.

A transmitting means comprises the control unit 22 and the protocol control unit 23, a receiving means comprises the control unit 22 and the protocol control unit 23, a comparing means comprises the CPU 11, and a control means comprises the CPU 11.

In cases where the CAN controller 12 makes a self-diagnosis of the function of the data transmission from the message slot unit 21 to the intermediate buffer 24, an arbitrary slot of the message slot unit 21 is specified by the CPU 11, and a slot number of the specified slot is registered in the slot specifying register 43 under the control of the CPU 11. Thereafter, a load entry signal Sle set to an active level (or a high level) is sent from the CPU 11 to the slot read-write control circuit 43 through the decoder 45, the slot read-write control circuit 43 refers to the slot number registered in the slot specifying register 43 according to the load entry signal Sle, the slot read-write control circuit 43 has access to the message slot unit 21, specific data stored in the specific slot of the slot number is read out to the slot read-write control circuit 43, and the specific data read out to the slot read-write control circuit 43 is loaded to the intermediate buffer 24. Thereafter, in the CPU 11, the specific data of the intermediate buffer 24 is compared with the specific data still stored in the specific slot of the message slot unit 21. Therefore, even though data stored in one slot of the message slot unit 21 is undesirably changed to erroneous data due to a certain failure in the data transmission from the message slot unit 21 to the intermediate buffer 24, the undesirable change of the data in the data transmission can be detected in the CPU 11.

Next, a case where the CAN controller 12 makes a self-diagnosis of the function of the data transmission from the intermediate buffer 24 to the message slot unit 21 will be described below. When serial data is received in the protocol control unit 23, serial-to-parallel conversion processing is performed for the serial data in the protocol control unit 23 to obtain reception data, and the reception data is stored in the intermediate buffer 24. Thereafter, a slot number of a specific slot of the message slot unit 21 is registered in the slot specifying register 43a by the CPU 11. Thereafter, a storage entry signal Sse set to an active level is sent from the CPU 11 to the slot read-write control circuit 43 through the decoder 45, the slot read-write control circuit 43 refers to the slot number registered in the slot specifying register 43 according to the storage entry signal Sse, the slot read-write control circuit 43 has access to the message slot unit 21, and the reception data read out from the intermediate buffer 24 is stored in the specific slot of the slot number under the control of the CPU 11. Thereafter, in the CPU 11, the reception data still stored in the intermediate buffer 24 is compared with the reception data stored in the specific slot of to the message slot unit 21. Therefore, even though data stored in the intermediate buffer 24 is undesirably changed to erroneous data due to a certain failure in the data transmission from the intermediate buffer 24 to the message slot unit 21, the undesirable change of the data in the data transmission can be detected in the CPU 11.

As is described above, in the fourth embodiment, the CAN controller 12 makes a self-diagnosis of the function of the data transmission between the intermediate buffer 24 and the message slot unit 21. Though an area for the failure detection is smaller than that in the first embodiment, because the outputting of serial data Tx from the protocol control unit 23 is not required, a failure detection time or a time for the self-diagnosis can be shortened.

Embodiment 5

In the fourth embodiment, when the load entry signal Sle or the storage entry signal Sse is output from the decoder 45 to the slot read-write control circuit 43, the slot read-write control circuit 43 has access to the message slot unit 21. However, in cases where the load entry signal Sle or the storage entry signal Sse is erroneously set to an active state in the decoder 45 during the communication, undesired data transmission is performed between the intermediate buffer 24 and the message slot unit 21. In a fifth embodiment, the erroneous setting of the load entry signal Sle or the storage entry signal Sse to an active level is prevented.

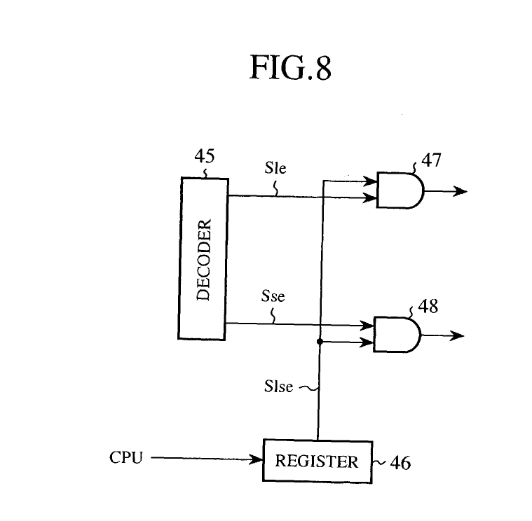

FIG. 8 is a view showing the configuration of a portion of control unit of a CAN controller according to a fifth embodiment of the present invention. The constituent elements, which are the same as those shown in FIG. 7, are indicated by the same reference numerals as those of the constituent elements shown in FIG. 7, and additional description of those constituent elements is omitted.

In FIG. 8, 46 indicates a register (or data transfer permitting means) for outputting a load storage entry signal Slse of the high level under the control of the CPU 11. 47 indicates an AND circuit (or data transfer permitting means) for outputting the load entry signal Sle of the active level when the load storage entry signal Slse of the high level and the load entry signal Sle of the active level are received. 48 indicates an AND circuit (or data transfer permitting means) for outputting the storage entry signal Sse of the active level when the load storage entry signal Slse of the high level and the storage entry signal Sse of the active level are received.

In cases where the CAN controller 12 makes the self-diagnosis of the function of the data transmission between the intermediate buffer 24 and the message slot unit 21, a load storage entry signal Slse of the high level is output from the register 46 to the AND circuits 47 and 48 under the control of the CPU 11, the load entry signal Sle of the active level or the storage entry signal Sse of the active level is output from the decoder 45 to the AND circuit 47 or 48 under the control of the CPU 11, and the load entry signal Sle of the active level or the storage entry signal Sse of the active level is output from the AND circuit 47 or 48 to the slot read-write control circuit 43.

Therefore, only when the CAN controller 12 makes the self-diagnosis of the function of the data transmission between the intermediate buffer 24 and the message slot unit 21, the comparing processing can be performed in the CPU 11. Accordingly, an erroneous operation of the self-diagnosis can be prevented in the CAN controller 12.

Embodiment 6

In the first and second embodiments, it is checked whether or not an error occurs in the data transmission, and the CAN controller 12 makes the self-diagnosis of the function of the data transmission. In contrast, in a sixth embodiment, it is checked whether or not an error occurs in the data reception.

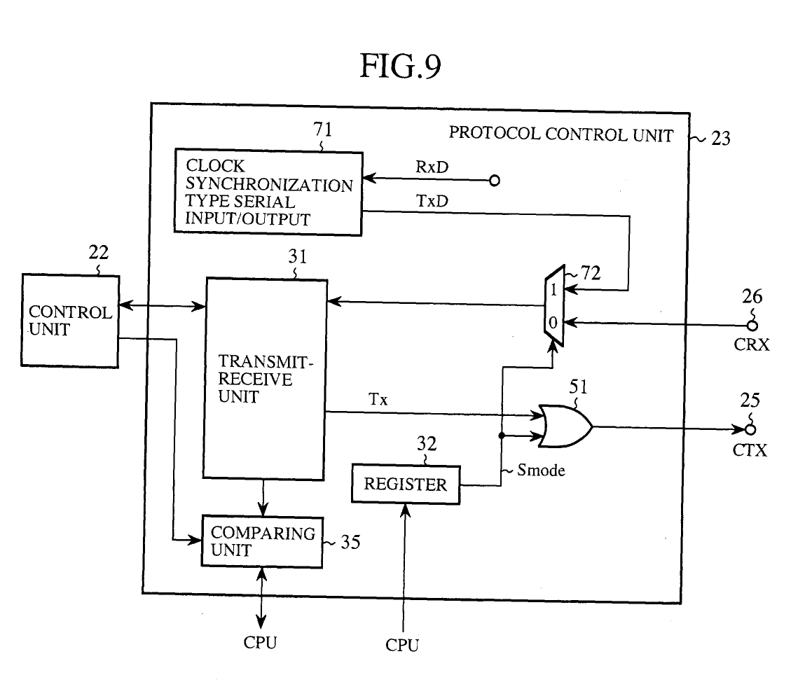

FIG. 9 is a view showing the configuration of a protocol control unit of a CAN controller according to a sixth embodiment of the present invention. The constituent elements, which are the same as those shown in FIG. 5, are indicated by the same reference numerals as those of the constituent elements shown in FIG. 5, and additional description of those constituent elements is omitted.

In FIG. 9, 71 indicates a clock synchronization type serial input/output (or quasi-communication means) for registering quasi-reception data produced according to the CAN protocol under the control of the CPU 11, performing parallel-to-serial conversion for the quasi-reception data to produce quasi-serial data TxD and outputting the quasi-serial data TxD. 72 indicates a selector for receiving the quasi-serial data TxD output from the clock synchronization type serial input/output 71, receiving serial data input to the reception terminal (CRX) 26 through the CAN bus 16 (refer to FIG. 1), receiving the mode entry signal Smode from the register 32, outputting the serial data to the transmit-receive unit 31 in case of the reception of the mode entry signal Smode of the low level, and outputting the quasi-serial data TxD to the transmit-receive unit 31 in case of the reception of the mode entry signal Smode of the high level.

In this embodiment, the protocol control unit 23, the control unit 22 and the message slot unit 21 are set to the state of the data reception.

Next, a self-diagnosis of the function of the data reception made in the CAN controller 12 will be described below.

The mode entry signal Smode of the high level is produced in the register 32 under the control of the CPU 11 and is output to the selector 72. Also, quasi-serial data TxD produced under the control of the CPU 11 according to the CAN protocol is output from the clock synchronization type serial input/output 71 to the selector 72, and serial data received at the reception terminal (CRX) 26 is input to the selector 72. In the selector 72, when the mode entry signal Smode of the high level is received, the quasi-serial data TxD output from the clock synchronization type serial input/output 71 is output to the transmit-receive unit 31 in place of the serial data received at the reception terminal (CRX) 26, and serial-to-parallel conversion processing is performed for the quasi-serial data TxD to obtain reception data.

Also, the quasi-reception data registered in the clock synchronization type serial input/output 71 is stored in advance in a memory (not shown) under the control of the CPU 11. The quasi-reception data stored in advance in the memory is readout to the comparing unit 35, and the reception data received in the transmit-receive unit 31 is sent to the comparing unit 35. In the comparing unit 35, the reception data is compared with the quasi-reception data. In cases where the reception data differs from the quasi-reception data, the CPU 11 judges that an error occurs in the reception data in the data reception performed in the transmit-receive unit 31. Accordingly, the CAN controller 12 can make the self-diagnosis of the function of the data reception.

In the sixth embodiment, the data comparing operation is performed in the comparing unit 35. However, in the same manner as in the first or second embodiment, it is applicable that the reception data stored in one slot of the message slot unit 21 is compared with the quasi-reception data stored in another slot of the message slot unit 21 under the control of the CPU 11. In this case, the CAN controller 12 can make the self-diagnosis of the function of the data reception in a communication line from the protocol control unit 23 to the message slot unit 21.

Also, in the first to sixth embodiments, the dominant level defined according to the CAN protocol is set to the low level, and the recessive level defined according to the CAN protocol is set to the high level. However, it is applicable that the dominant level be set to the high level and the recessive level be set to the low level.

What is claimed is:

1. A controller area network controller comprising:
diagnosis receiving means for receiving a request of a diagnosis;
loop back means for reading out transmission data stored in a slot, outputting the transmission data to a controller area network bus through a transmission terminal as serial data, and receiving the serial data output to the controller area network bus through a reception terminal as loop back data in response to the request of the diagnosis received by the diagnosis receiving means;
comparing means for comparing the transmission data stored in the slot and the loop back data received by the loop back means to obtain a comparison result; and
control means for making a diagnosis of a function of the data transmission according to the comparison result obtained by the comparing means.

2. The controller area network controller according to claim 1, wherein the transmission data output from the loop back means is sent to the comparing means by the loop back means as the loop back data without outputting the transmission data to the controller area network bus to make the comparing means compare the transmission data stored in the slot and the loop back data sent by the loop back means.

3. The controller area network controller according to claim 2, further comprising:
data changing means for specifying a bit of the serial data output by the loop back means, specifying a level of the specified bit of the serial data, producing the loop back data by setting the specified bit of the serial data output by the loop back means to the specified level, and sending the loop back data to the loop back means.

4. The controller area network controller according to claim 1, wherein the control means controls the comparing means to compare the transmission data stored in the slot and the loop back data received by the loop back means in response to the completion of the transmission of the transmission data from the loop back means.

5. The controller area network controller according to claim 1, further comprising:
a message slot unit having the slot of the transmission data and a second slot,
wherein the loop back data received by the loop back means is stored in the second slot of the message slot unit by the control means, and the control means controls the comparing means to compare the transmission data of the slot and the loop back data of the second slot.

6. A controller area network controller, comprising:
transmitting means for transferring transmission data stored in a slot to an intermediate buffer in a transmission operation and outputting the transmission data of the intermediate buffer to a controller area network bus;
receiving means for receiving reception data through the controller area network bus in a reception operation, transferring the reception data to the intermediate buffer and storing the reception data of the intermediate buffer in a slot;
comparing means for comparing the transmission data of the intermediate buffer and the transmission data stored in the slot in the transmission operation or comparing the reception data of the intermediate buffer and the reception data stored in the slot in the reception operation; and
control means for making a diagnosis of a function of the data transmission or a diagnosis of a function of the data reception according to a comparison result obtained by the comparing means.

7. The controller area network controller according to claim 6, wherein the control means specifies the slot in the transmission operation or the reception operation, and the transmitting means or the receiving means has access to the slot specified by the control means to transfer the transmission data from the slot or transfer the reception data to the slot.

8. The controller area network controller according to claim 7, further comprising:
data transfer permitting means for permitting the transfer of the transmission data from the slot to the intermediate buffer in the transmission operation or permitting the transfer of the reception data from the intermediate buffer to the slot in the reception operation.

9. A controller area network controller, comprising:
quasi-communication means for registering quasi-reception data based on a controller area network protocol and outputting the quasi-reception data as quasi-serial data;
selecting means for receiving both serial data transmitted through a controller area network bus and the quasi-serial data output from the quasi-communication means and selecting the quasi-serial data output from the quasi-communication means in response to a request of a diagnosis;
receiving means for receiving the quasi-serial data selected by the selecting means as reception data;
comparing means for comparing the reception data received by the receiving means and the quasi-reception data registered by the quasi-communication means; and
control means for making a diagnosis of a function of the data reception according to a comparison result obtained by the comparing means.

10. The controller area network controller according to claim 9, further comprising:
a message slot unit having a first slot and a second slot, wherein the quasi-reception data registered by the quasi-communication means is stored in the first slot of the message slot unit by the control means, the reception data received by the receiving means is stored in the second slot of the message slot unit by the control means, and the control means controls the comparing means to compare the reception data of the second slot and the quasi-reception data of the first slot.
